(19) United States
(12) Patent Application Publication
(10) Pub. No.: US 2026/0359952 A1
(43) Pub. Date: Nov. 12, 2026

(54) INDUSTRIAL CAMERA WITH IMAGE RECONSTRUCTION FOR OPTICS EQUIPPED WITH A MULTIFOCAL ELEMENT

(71) Applicant: OPTO ENGINEERING S.P.A., MANTOVA (IT)

(72) Inventor: Andrea BERTOLUCCI, MANTOVA (IT)

(21) Appl. No.: 19/214,304

(22) Filed: May 21, 2025

(30) Foreign Application Priority Data
May 12, 2025 (IT) 102025000010617

(51) Int. Cl. G06T 5/73; G06T 5/20; G06T 5/70; G06T 5/80; G06T 7/80

(52) U.S. Cl. CPC G06T 5/73; G06T 5/20; G06T 5/70; G06T 5/80; G06T 7/80

(57) ABSTRACT

A computer-implemented method to obtain a focused object image from an object image of at least one observed object acquired using an image sensor optically coupled to a multifocal optical system. The method includes, using a deconvolution module, deconvolving the object image based on at least one optical parameter associated with the multifocal optical system, in order to obtain a deconvolved object image (step a). The method further includes, using a post-deconvolution noise correction module, modifying the deconvolved object image based on the at least one optical parameter associated with the multifocal optical system, in order to obtain a focused object image (step b).

### CROSS-REFERENCE TO RELATED APPLICATIONS

This application claims the benefit of Italian patent application 102025000010617 filed 12 May 2025, the disclosure of which is incorporated herein by reference in its entirety.

### TECHNICAL FIELD

The present disclosure relates to a computer-implemented method for obtaining a focused object image starting from an object image of at least one observed object, in particular acquired by means of an image sensor optically coupled to a multifocal optical system.

The present disclosure also relates to an industrial camera, usable for example for carrying out dimensional measurements of objects, a vision system comprising such an industrial camera, a computer program and a computer program product.

In particular, the camera provided in the present disclosure is configured to acquire images in the following spectral ranges: ultraviolet A (UVA, from 315 nm to 400 nm), visible and near-infrared (VIS-NIR, from 400 nm to 900 nm) and short-wave infrared (SWIR, from 900 nm to 1700 nm).

The camera provided in the present disclosure can include, for example, a telecentric, entocentric or hypercentric objective.

### BACKGROUND

Telecentric objectives are optical systems widely used in the field of machine vision for carrying out non-contact measurements of objects, thanks to their specific property of collecting cones of light rays coming from the illuminated object in which the principal rays are parallel to the optical axis of the system itself. In this way, in fact, the size of the image created by the objective is independent of the distance at which the observed object is placed, allowing its measurement to be made more accurate, because it is free from the perspective effects characteristic of other types of optics.

This property, known as telecentricity, is achieved with an objective in which the entrance pupil is optically placed at infinity. This is made possible by the configuration of the optical elements placed between the stop aperture and the observed object, which form a front optical group with a positive focal length. The position of the focus of this group coincides with the position of the stop aperture. The configuration in which the stop aperture is positioned at the focus of the front optical group is called “object-side telecentric”. A telecentric objective, therefore, can select from the object only principal entrance rays parallel to the optical axis.

Entocentric objectives are conventional optical systems widely used in imaging. These objectives are characterized by the ability to collect cones of light rays coming from the illuminated object, in which the principal rays converge towards the front lens of the objective. This results in a perspective in which the dimensions of the object image decrease as the distance of the object from the objective increases, simulating the perspective vision of the human eye. In an entocentric objective, the stop aperture of the system is placed before the focal position of the optical group preceding it. The configuration of the optical elements of the objective is such that the light rays coming from the object are refracted and converge towards the image plane. The position of the stop aperture influences the perspective.

In a hypercentric objective, the stop aperture of the system is placed after the focal position of the optical group preceding it. Hypercentric objectives are optical systems whose entrance pupil is placed before the objective.

All optical objectives, including telecentric, entocentric or hypercentric ones, are characterized by a specific working distance (WD), defined as the distance between the observed object and the first element of the optical system. The light rays coming from the observed object are (at least partially) collected by the optical system and conveyed onto an image plane, where a sharp image of the object is formed and where an image sensor is typically positioned.

By varying the working distance, and therefore the position of the observed object with respect to the optical system, without modifying the position of the image sensor, the image formed on the sensor becomes less sharp. In particular, the sharpness of the produced image decreases as the difference between the new working distance and the original working distance increases.

The depth of field (DOF) of an optical system is defined as the difference between the maximum working distance and the minimum working distance for which the image on the sensor can still be considered sufficiently sharp. The sufficient sharpness threshold for considering an image acceptable depends on the specific application.

The depth of field can represent a significant limitation in some imaging applications. This occurs, for example, when the object to be observed has a dimension along the optical axis greater than the depth of field of the optical system itself, or when it is desired to simultaneously visualize two objects placed at relative distances from each other greater than the depth of field of the optical system.

A possible solution to increase the depth of field of an optical system includes using a multifocal optical element.

In many industrial applications, such as automated quality control or surface inspection, it is fundamental to obtain images of objects in which all details are clearly focused. Traditional optics, however, have a limited depth of field, which means that only objects at a specific distance from the objective appear sharp in the acquired image. This represents a challenge when objects with height variations must be inspected or when objects placed at different distances must be observed. Multifocal optics can overcome this problem, but the images they generate require further processing.

In fact, an optical system equipped with a multifocal optical element is able to acquire and reproduce on the image plane, which corresponds to the sensor plane of the camera, images of objects placed at different distances from the optical system, within a certain operating range. In this way, the optical system superimposes all these images, obtaining a final image that corresponds to the sum of the individual contributions coming from the different images of the different objects.

Evidently, this operating range is greater than the range that the same lens would have in the absence of the multifocal optical element.

The image resulting from the superimposition of different focused and out-of-focus images, obtained with a multifocal optical system, is not directly usable for human vision or for processing by a computer. The superimposition, in fact, drastically reduces the contrast of the image and decreases its sharpness, making it difficult to distinguish the details of the objects.

In other words, the presence of out-of-focus rays that pass through the stop aperture of the objective does not contribute to the formation of a sharp image and, in general, worsens the quality of the image itself.

Therefore, in the imaging sector, there is a strong need to focus images obtained through a multifocal optical element, thus extending the depth of field of an objective without compromising its resolution.

### SUMMARY

The present disclosure therefore provides a computer-implemented method capable of resolving, at least partially, the drawbacks described above. In particular, the present disclosure proposes a computer-implemented method that overcomes the limitations imposed by the depth of field, while maintaining a high resolution.

This advantage is achieved by providing a computer-implemented method according to the claims. This is also achieved by providing an industrial camera according to the claims, a vision system according to the claims, a computer program according to the claims, and a computer program product according to the claims. The dependent claims describe preferred embodiments of the disclosure.

### BRIEF DESCRIPTION OF THE DRAWINGS

The characteristics and advantages of the computer-implemented method, the industrial camera, the vision system, the computer program and the computer program product according to the disclosure will however become evident from the description given below of preferred exemplary embodiments, provided by way of non-limiting example, with reference to the attached figures, in which:

FIG. 1 is a block diagram of an embodiment of the steps of the method in accordance with the present disclosure;

FIG. 2 is a block diagram of a variant embodiment of the steps of the method of FIG. 1;

FIG. 3 is a block diagram of a variant embodiment of the steps of the method of FIG. 1;

FIG. 4 is a perspective view of an industrial camera in accordance with the present disclosure;

FIG. 5 is a schematic representation of a vision system in accordance with the present disclosure;

FIGS. 6a and 6b are schematic representations of the depth of field obtained respectively with an industrial camera without a multifocal optical element and an industrial camera comprising a multifocal optical element;

FIGS. 7a and 7b respectively show an example of an object image before and after the deconvolution process;

FIGS. 8a-8c respectively show an example of an object image before the deconvolution process, before the post-deconvolution noise correction process and after the post-deconvolution noise correction process;

FIGS. 9a-9c respectively show an example of an object image before the post-deconvolution noise correction process, after the post-deconvolution noise correction process carried out through an average of multiple acquisitions and after the DSNU and PRNU post-deconvolution noise correction process;

FIGS. 10a-10c respectively show a graph of a PSF model (S_model) coinciding with the real PSF (S_real), an example of an object image before the deconvolution process and the same object image after the deconvolution process; and

FIGS. 11a-11c respectively show a graph of a PSF model (S_model) different from the real PSF (S_real), an example of an object image before the deconvolution process and the same object image after the deconvolution process.

### DETAILED DESCRIPTION OF THE DRAWINGS

In the following of the present description, the connecting references (for example, fixed, coupled, connected and the like) must be interpreted in a broad sense and can include intermediate elements between a connection of elements and a relative movement between elements.

Therefore, the connecting references do not necessarily imply that two elements are connected directly and in a fixed relationship with each other.

The computer-implemented method according to the present disclosure is suitable for obtaining a focused object image FI starting from an object image I of at least one observed object O acquired by means of an image sensor S optically coupled to a multifocal optical system MOS.

In the following of the present description, by “multifocal optical element” is meant an element belonging to one of the following categories:
Multifocal optical elements with a focal length that varies as a function of the radial position along the optical element itself, i.e. elements in which incident rays at different distances from the optical axis are focused at different distances. This category of multifocal optical element includes axicons and some types of aspheric lenses.
Multifocal optical elements with a focal length independent of the radial position along the optical element itself. This category includes liquid lenses, lenses with chromatic aberration and diffractive lenses.

The multifocal optical element is configured to generate a plurality of object focus planes.

In other words, once the position of the image plane, where for example an image sensor is positioned, is fixed, the multifocal optical element creates a set of object planes conjugate with the image plane, effectively increasing the depth of field of the starting system and producing a more extended depth of field.

In the following of the present description, by “set of object planes conjugate with the image plane” is meant the property of an optical system (such as a lens) to create focused images of objects placed at different distances. For each distance of the object from the lens, there is a corresponding distance of the image plane (the plane where the image of the object is formed) in which the image is sharp. In an optical system, for each object plane (the plane where the observed object is located), there is a corresponding image plane in which the image of the object is focused. These planes are called “conjugate”. Furthermore, two points or planes are “conjugate” if the light rays coming from a point of the object converge at a corresponding point of the image.

By changing the distance of the object from the lens, the distance of the image plane (where the sharp image is formed) changes accordingly. The set of all possible object planes and their corresponding conjugate image planes describes the ability of the optical system to focus objects at different distances. This concept is closely related to the depth of field of an objective, which determines the range of distances in which objects appear reasonably focused.

The numerical references to the steps of the method reported below are also reported in the aforementioned attached figures.

It is clear that the fact that the method for obtaining a focused object image FI starting from an object image I according to the present disclosure is computer-implemented means that all the steps of this method that will be described below can be executed by an electronic processing unit, such as an electronic processor, a CPU or a GPU or the like, configured by means of appropriate code capable of being executed by this electronic processing unit.

It is also clear that the method for obtaining a focused object image FI starting from an object image I according to the present disclosure can also be executed by an electronic device that includes this electronic processing unit.

Furthermore, even if the steps of a method are presented as distinct, some can be performed simultaneously. The exemplary embodiments can combine separate steps into a single one or divide a single step into multiple sub-steps.

In the following description, the term “connected” refers to both a direct electrical connection between two circuit elements and an indirect connection through one or more intermediate active or passive elements.

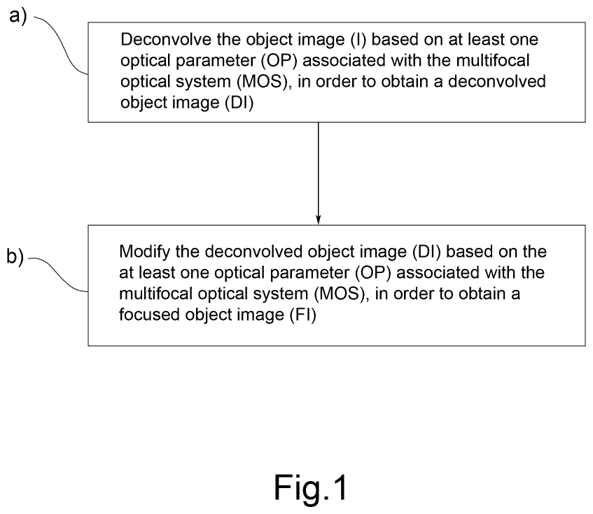

In accordance with a general aspect of the disclosure, the method for obtaining a focused object image FI starting from an object image I of at least one observed object O acquired by means of an image sensor S optically coupled to a multifocal optical system MOS comprises the following steps, illustrated by way of example in FIG. 1.

The method comprises, by means of a deconvolution module, deconvolving the object image I based on at least one optical parameter OP associated with the multifocal optical system MOS, in order to obtain a deconvolved object image DI (step a)).

In the following of the present description, by “convolution” of an image is meant a mathematical operation that combines each pixel of this image with the nearest pixels, through a filter (or “kernel”), thus producing a modified image.

Mathematically, given a two-dimensional image f(x,y) and a kernel h(i,j), the “convolution g(x,y)” is defined by the following function:

g(x,y)=(f*h)(x,y)=ΣᵢΣⱼh(i,j)·f(x−i,y−j)

In the following of the present description, by “deconvolution” of an image is meant the inverse process of convolution, which allows the original image to be recovered from the resulting image and the known kernel. This deconvolution is usually performed in the Fourier domain, where convolution can be expressed by a multiplication, as follows:

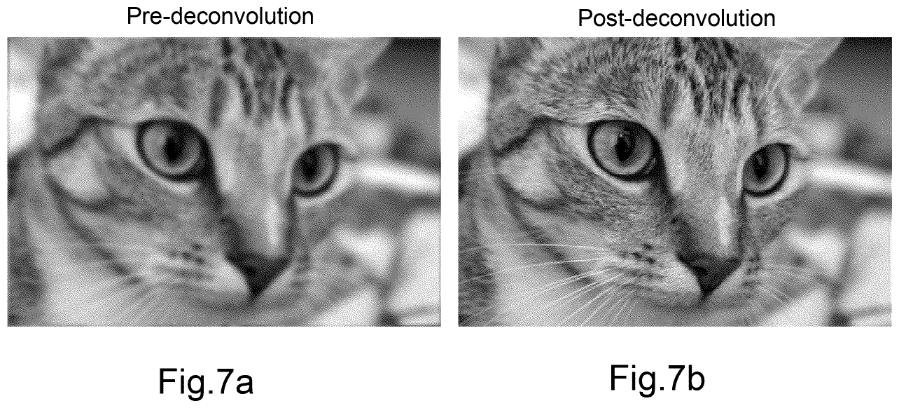

FFT(g)=FFT(f)·FFT(h),
allowing the Fourier transform of the original image FFT(f) to be isolated, and then applying the inverse Fourier transform to return to the image space. Deconvolution can be used, for example, to remove blurring from an initially blurred image, as illustrated by way of example in FIGS. 7a and 7b.

The method then comprises, by means of a post-deconvolution noise correction module, modifying the deconvolved object image DI based on the at least one optical parameter OP associated with the multifocal optical system MOS, in order to obtain a focused object image FI (step b)).

In the following of the present description, by “post-deconvolution noise” (or “deconvolution noise”) is meant the undesirable effect that occurs during the process of recovering an original image from a blurred version of it, in the presence of noise. This occurs because the deconvolution process inevitably amplifies the noise included in the observed image compared to the true image. In fact, an observed image I(x,y) can be written in terms of the convolution of the true image Iₜᵣᵤₑ(x,y) with the kernel h(i,j), with the addition of a noise component n(x,y):

I(x,y)=(Iₜᵣᵤₑ*h)(x,y)+n(x,y)

Passing (in the deconvolution process) to the Fourier spectrum, the following relationship is obtained:

$$F FT ( I ) = F FT ( {I}_{t r u e} ) \cdot FFT ( h ) + FFT ( n )$$

$$FFT ( {I}_{d e c o n v} ) = \frac{F FT ( I )}{F F T ( h )} = F FT ( {I}_{t r u e} ) + \frac{1}{F F T ( h )} F F T ( n )$$

Therefore, the spectrum of the image reconstructed through deconvolution (I_{deconv}) includes the noise component FFT(n), amplified according to the factor 1/FFT(h) as a function of frequency. Since FFT(h) can take very small values at certain frequencies, the division can amplify the noise, severely degrading the image reconstruction.

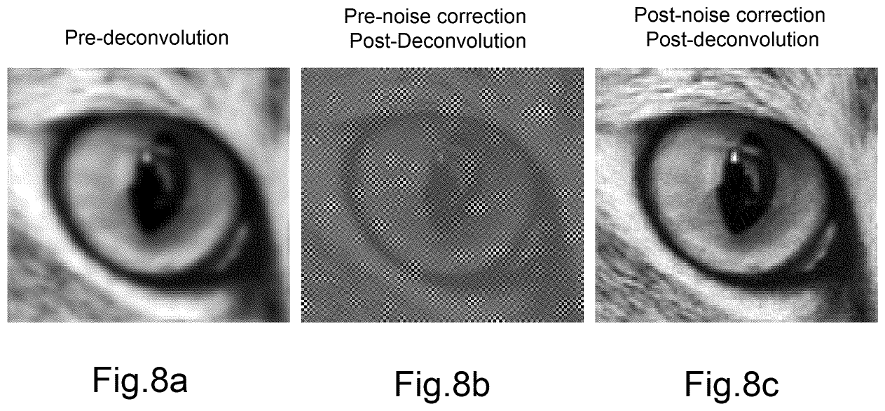

For this reason, it is possible to resort to methods such as the Wiener filter, or constrained deconvolution, which balance the recovery of details with the suppression of the signal at those frequencies where the noise is amplified. The undesirable effect of deconvolution noise (and its suppression) are illustrated by way of example in FIGS. 8a-8c.

In the following of the present description, by “image sensor” is meant a component responsible for capturing the light coming from an optical system and converting it into an electrical signal, thus generating a digital representation of the image.

For example, the image sensor S is a CCD or CMOS sensor.

The sensor S is optically coupled to a multifocal optical element MOS, an optical component designed to modify the path of light so that the image of the object is formed not on a single plane, as occurs in traditional optics, but over a range of distances. In this way, the system is able to acquire images of objects located at different distances.

In the following of the present description, by an image sensor “optically coupled” to the multifocal optical element is meant that the image sensor is positioned to receive the light that passes through this multifocal optical element.

The use of an image sensor connected to a multifocal optical element makes it possible to obtain images with a greater depth of field compared to traditional optical systems. This characteristic is particularly advantageous in applications where the objects to be observed are located at variable distances.

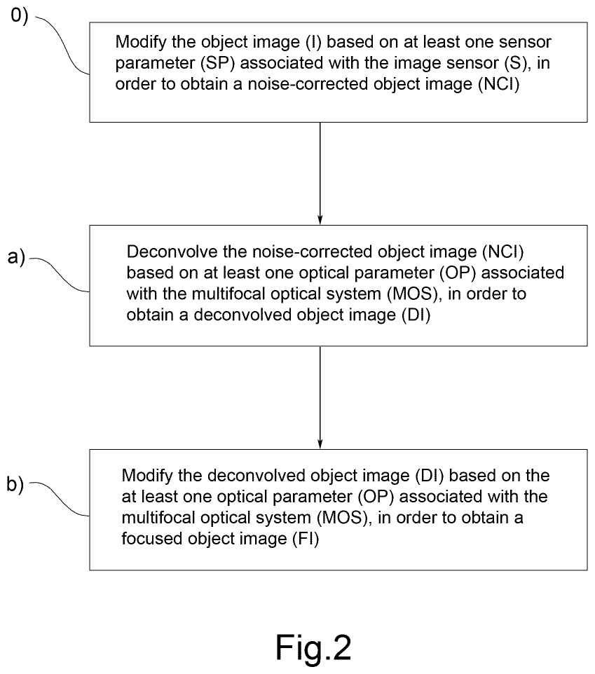

In one embodiment, the method comprises, before step a), the following step, illustrated by way of example in FIG. 2.

In this embodiment, the method comprises, by means of a sensor noise correction module, modifying the object image I based on at least one sensor parameter SP associated with the image sensor S, in order to obtain a noise-corrected object image NCI (step 0)). In this embodiment, step a) comprises deconvolving the noise-corrected object image NCI.

Each image sensor introduces noise into the acquired image. Part of this noise is an intrinsic characteristic of the individual sensor and remains constant over time. This characteristic noise is caused by variations in the response of the individual pixels of the sensor. Common examples of characteristic noise are Photo Response Non-Uniformity (PRNU) and Dark Signal Non-Uniformity (DSNU). The sensor parameter SP represents a set of data that quantifies the characteristic noise of a particular sensor.

The correction of the characteristic noise of the sensor allows improving the quality of the acquired image, reducing artifacts and increasing contrast. This aspect is of particular importance in machine vision applications that require high image precision.

In particular, the correction of the sensor noise must be based on appropriate descriptive models of the systematic imperfections of the pixels. Firstly, a temporal noise is distinguished, usually due to “shot noise” or “readout noise”, which causes differences in successive images even if acquired under the same conditions and with the same exposure time. To reduce this type of noise, it is possible to average multiple successive acquisitions:

$${I}_{m e a n} ( x , y ) = \frac{1}{N} {\sum }_{k = 1}^{N} {I}_{k} ( x , y )$$

The main components of the FPN (Fixed Pattern Noise) are DSNU and PRNU. The DSNU (Dark Signal Non-Uniformity) is the variation of the signal between pixels in the absence of light (Dark Signal). This type of noise can be corrected by subtracting a dark frame I_{DSNU}(x,y), acquired with the same exposure time with the shutter closed, from the acquired image I(x,y):

I_{corr}(x,y)=I(x,y)−I_{DSNU}(x,y)

In this way, in addition to eliminating the contribution of the Dark Signal which causes a reduction in Dynamic Range and contrast, the non-uniformity between pixels related to this factor is also reduced.

Finally, the PRNU (Photo Response Non-Uniformity) is the variation in the response of the pixels to the light signal. This noise can be corrected by dividing the image, previously corrected by subtracting the dark frame, by a gain map:

$${I}_{c o r r} ( x , y ) = \frac{I ( x , y ) - {I}_{DSNU} ( x , y )}{G ( x , y )}$$

Where G(x,y) is the gain map often obtained previously from a uniform image of a homogeneous light source:

$$G ( x , y ) = \frac{{I}_{h omogeneous} ( x , y ) - {I}_{DSNU} ( x , y )}{mean ( {I}_{h omogeneous} ( x , y ) - {I}_{DSNU} ( x , y ) )}$$

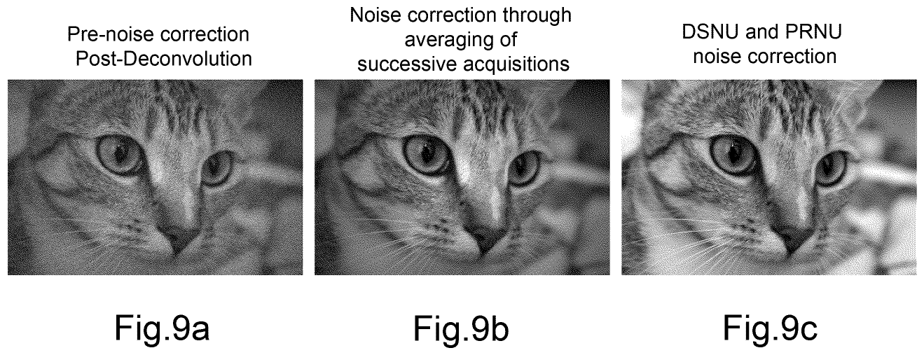

In this way, it is possible to make the response of the pixels more uniform for the same input light signal. An example of noise reduction operations is shown by way of example in FIGS. 9a-9c.

Deconvolution is an image processing technique used to improve the sharpness of an image that appears blurred. Blurring is a consequence of the fact that the optical system fails to perfectly focus all points of the object onto a single point of the sensor. Deconvolution attempts to reverse this blurring process, using a mathematical model of the optical system.

The application of deconvolution makes it possible to obtain sharper and more detailed images, facilitating their analysis and interpretation. This is particularly useful in application contexts where it is necessary to accurately measure the dimensions of objects or identify small details.

The optical parameter OP is a set of data that describes the optical properties of the multifocal optical system. These parameters are necessary to perform the deconvolution of the image. Examples of optical parameters are the Point Spread Function PSF and the Modulation Transfer Function MTF.

As is known, a single point source on the object plane is mapped by an optical system onto the image plane as a luminous spot, more or less extended, with a certain intensity profile distributed within it. This intensity profile is called the Point Spread Function (PSF) and precisely represents the response of the optical system to a single point source. The final image is therefore the convolution of the intensity profile on the object plane with the PSF of the optical system.

In the known case of a single ideal lens, the PSF corresponds to the Airy pattern, a function of the radial coordinate r:

$$P S F ( r ) = {( 2 {R}_{a i r y} \frac{{J}_{1} ( 1.22 π \frac{τ}{{R}_{airy}} )}{1.22 π r} )}^{2}$$

where R_{airy} is the radius of the Airy disk which depends on the optical parameters of the lens.

The MTF represents the ability of the system to transfer contrast at different spatial frequencies. Mathematically, the MTF corresponds to the modulus of the Fourier transform of the PSF. In the case of an ideal lens, the MTF is calculated using the following function:

$$M T F ( f ) = \frac{2}{π} ( arccos ( \frac{f}{{f}_{max}} ) - \frac{f}{{f}_{max}} \sqrt{1 - {( \frac{f}{{f}_{max}} )}^{2}} )$$

To apply a correct deconvolution of the blurred image obtained with a specific optical system, it is important to have a precise model or measurement of the PSF and/or MTF of that optical system, in order to eliminate (or reduce) the effect of blurring.

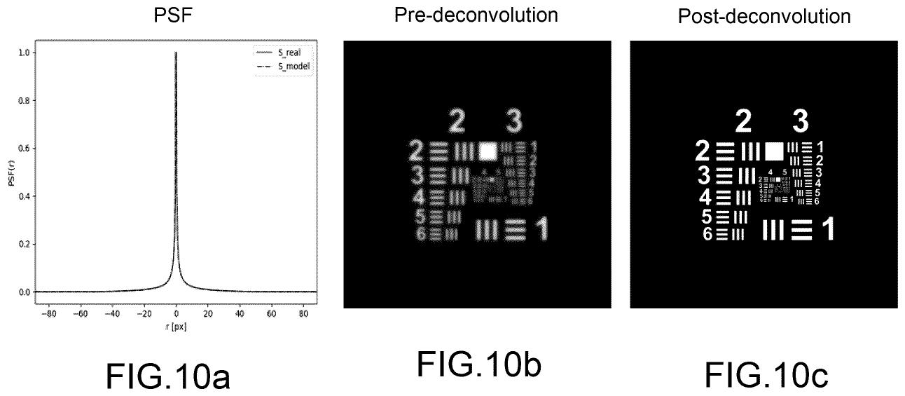

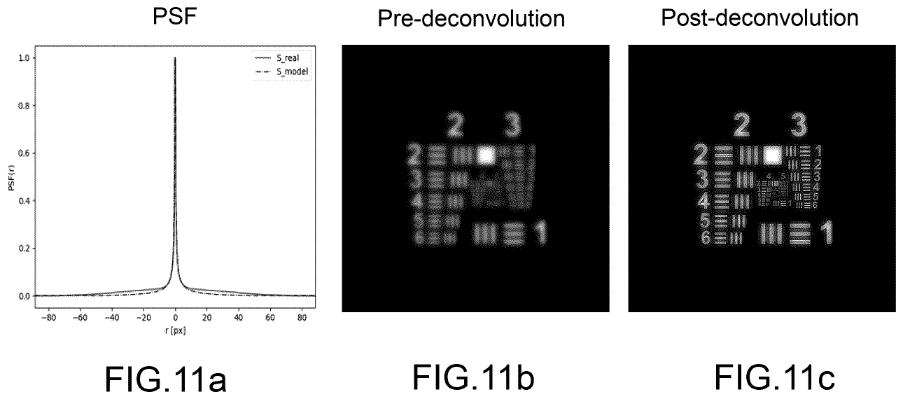

Examples of post-deconvolution noise removal are shown by way of example in FIGS. 10a-10c and 11a-11c.

In particular, FIG. 10a shows a simulation of a case in which the PSF S_model(r), used as a model to deconvolve the blurring effect, is perfectly consistent with the hypothetical real PSF S_real(r) that produced the blurred image of a USAF1951 target, shown by way of example in FIG. 10b. By deconvolving the image using S_model(r) as the PSF, it is possible to successfully reconstruct the image of the USAF1951 target, shown by way of example in FIG. 10c, reducing the blurring effect.

FIG. 11a shows the case in which the PSF S_model(r), used as a model to deconvolve the blurring effect, deviates slightly from the hypothetical real PSF S_real(r) that produced the blurred image of a USAF1951 target, shown by way of example in FIG. 11b. By deconvolving the image using S_model(r) as the PSF, it is possible to reconstruct the image of the USAF1951 target, shown by way of example in FIG. 11c, but only partially reducing the blurring effect and causing the appearance of some artifacts.

The use of accurate optical parameters makes it possible to obtain a more effective deconvolution, producing sharper images with fewer artifacts.

The deconvolution process can have the undesirable effect of amplifying the noise already present in the original image. For this reason, it is useful to apply a post-deconvolution noise correction step after the deconvolution step. This post-deconvolution noise correction step is aimed at reducing the noise amplified by the deconvolution, without excessively blurring the image.

In other words, the image reconstructed by the deconvolution process may present noise that degrades its final quality. This noise can originate from the non-ideality of the optical model compared to the real physical system, from the intrinsic quality of the deconvolution algorithms used, or from a high level of noise present in the starting image, amplified during the processing steps. In order to mitigate the introduced noise and obtain a usable image, noise reduction (denoising) algorithms are therefore applied.

Post-deconvolution noise correction makes it possible to obtain images that present a good balance between sharpness and noise level.

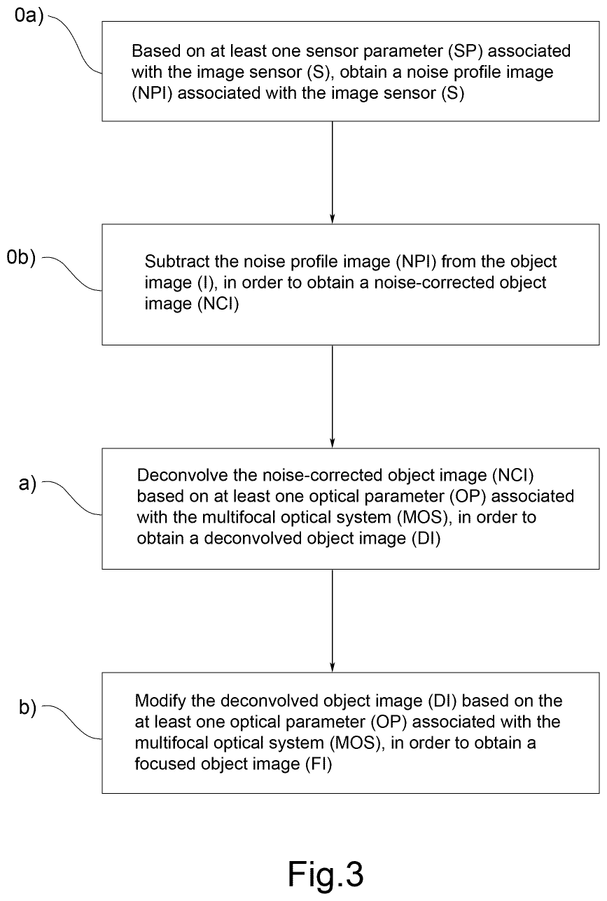

In one embodiment, the sensor noise correction step of the method for obtaining a focused object image FI starting from an object image I comprises the following sub-steps, illustrated by way of example in FIG. 3.

The sensor noise correction step comprises, based on at least one sensor parameter SP associated with the image sensor S, obtaining a noise profile image NPI associated with this image sensor S (sub-step 0a)).

The sensor noise correction step then comprises subtracting the noise profile image NPI from the object image I, in order to obtain a noise-corrected object image NCI (sub-step 0b)).

In the following of the present description, by “noise profile image” is meant a spatial representation of the characteristic noise of the sensor. In other words, the noise profile image is an image that indicates the amount of noise present in each pixel of the sensor. The noise profile image is used to correct the characteristic noise in the acquired image.

The use of a noise profile image makes it possible to obtain a more precise noise correction compared to the use of a single average noise value.

The operation of subtracting the noise profile image from the acquired image includes subtracting the value of each pixel of the noise profile image from the corresponding pixel value in the acquired image. This process reduces or eliminates the characteristic noise present in the acquired image.

The subtraction of the noise profile image is a simple and effective method for correcting the characteristic noise of the sensor.

In one embodiment, the at least one sensor parameter SP associated with the image sensor S and/or the noise profile image NPI associated with the image sensor S are obtained from a database previously stored on electronic storage means.

For example, the sensor parameters and/or the noise profile image can be stored in any type of memory. Examples of memories include solid-state memories (such as flash memories), hard disks, and optical memories. The memory can be integrated into the camera or be external to it.

The storage of the sensor parameters and/or the noise profile image allows the sensor calibration information to be used even after the camera is turned off. This simplifies the use of the camera and ensures consistent noise correction over time.

In one embodiment, the noise profile image NPI associated with the image sensor S corresponds to a Photo Response Non-Uniformity PRNU noise and/or a Dark Signal Non-Uniformity DSNU noise.

Photo Response Non-Uniformity PRNU noise is a variation in the light sensitivity of the different pixels of the sensor. In other words, even if all pixels receive the same amount of light, some pixels may produce a more intense signal than others. Dark Signal Non-Uniformity DSNU noise is a variation in the signal produced by the different pixels of the sensor in the absence of light. This means that, even in the absence of light, some pixels may generate a small electrical signal.

The correction of PRNU and DSNU makes it possible to obtain images with more uniform brightness and color.

In one embodiment, the deconvolution step comprises deconvolving the noise-corrected object image NCI based on a Point Spread Function PSF and/or a Modulation Transfer Function MTF associated with the multifocal optical system MOS.

The Point Spread Function PSF describes the way a point of light is blurred by the optical system. In technical terms, the PSF represents the response of the optical system to a point source. The Modulation Transfer Function MTF describes the ability of the optical system to transfer contrast from the object to the image. In practice, the MTF indicates how well the optical system is able to reproduce the fine details of the object. The PSF and MTF are important parameters for image deconvolution.

The use of the PSF and the MTF allows for a more accurate deconvolution, producing sharper images with fewer artifacts.

In one embodiment, the Point Spread Function PSF and/or the Modulation Transfer Function MTF associated with the multifocal optical system MOS are obtained from a database previously stored on electronic storage means.

In one embodiment, the post-deconvolution noise correction step comprises modifying the deconvolved object image DI by means of a filter, for example a Gaussian filter.

In the following of the present description, and in the context of image processing, a “filter” is an algorithm used to modify the image in a specific way. A Gaussian filter, for example, is a type of filter that blurs the image in order to reduce noise. Other commonly used filters include the median filter, the bilateral filter, and the Sobel filter.

Filters can be used for various purposes, including noise reduction, contrast enhancement, edge highlighting, and performing other operations on the image.

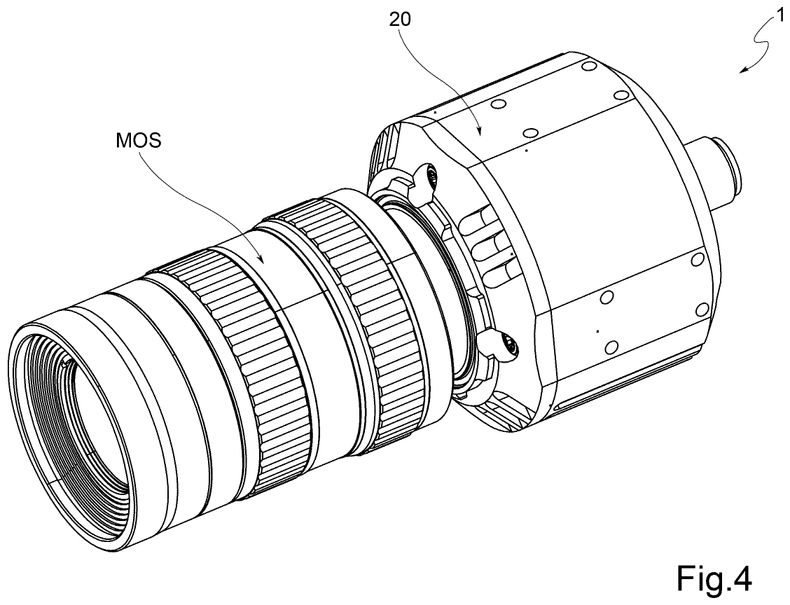

Furthermore, the present disclosure also relates to an industrial camera 1, illustrated by way of example in FIG. 4.

In a general embodiment, the industrial camera 1 comprises a camera body 20 supporting a multifocal optical system MOS optically coupled to at least one image sensor S. This image sensor S is suitable for acquiring at least one object image I of at least one observed object O.

In a general embodiment, the industrial camera 1 further comprises a processing unit configured to perform the steps of the method described above.

In one embodiment, the industrial camera 1 further comprises an intensity modulator optically coupled to the multifocal optical system MOS. This intensity modulator is configured to modulate in intensity the rays coming from the at least one observed object O.

In the following of the present description, by “intensity modulator” is meant an optical device that modifies the intensity of a light beam, for example by reducing it by a predetermined factor.

In one embodiment, the intensity modulator is an apodizing filter.

In the following of the present description, by “apodizing filter” is meant an optical device that modifies the intensity distribution of light in an optical system. In particular, an apodizing filter attenuates the side lobes (or “tails”) in the response function of the optical system, reducing or eliminating the undesirable effects of diffraction, which can cause artifacts or distortions in images.

Typically, the Point Spread Functions generated by points coming from different object planes can be very different from each other.

The use of an intensity modulator, for example an apodizing filter, thanks to the modulation and/or damping of out-of-focus rays, makes the Point Spread Functions generated by different object planes more similar to each other. Therefore, the use of the intensity modulator allows considering a single “average” Point Spread Function, obtained by averaging (for example, an arithmetic, geometric or weighted average) the different Point Spread Functions. The average Point Spread Function accurately describes the behavior of the optical system for the different object planes.

This allows the resulting image, thanks to the homogeneous behavior in the extended depth of field region, to have sufficient contrast and resolution to be usable for machine vision applications.

The use of an intensity modulator, for example an apodizing filter, allows the final image to be processed through the deconvolution process using a single average Point Spread Function.

In one embodiment, the industrial camera 1 further comprises a transfer unit configured to transfer the focused object image FI to at least one external electronic unit.

In the following of the present description, by “external electronic unit” is meant an electronic device separate from the camera. This unit is able to receive and process the images acquired by the camera. Common examples of external electronic units are computers, smartphones, tablets, and industrial control systems.

The use of an external electronic unit offers the possibility of processing images with greater computing power or displaying them on a larger display. Furthermore, it allows the camera to be integrated into a larger vision system.

In one embodiment, the multifocal optical system MOS comprises a multifocal optical element.

Preferably, the multifocal optical element is an axicon.

In the following of the present description, by “axicon” is meant a type of multifocal optical element characterized by a conical shape. Unlike traditional lenses, which focus light at a point, an axicon focuses a beam of light rays incident on it into a segment, creating a long and narrow focal line.

In other words, an axicon has a focal length that varies as a function of the radial coordinate along its surface.

The extent of the depth of field extension depends on the physical characteristics of the multifocal optical element. In particular, if the multifocal optical element is an axicon, the extent of the depth of field extension depends on the angle α that characterizes it.

The industrial camera is equipped with an image acquisition sensor designed to receive the image coming from the multifocal optical system. The image thus acquired by the sensor is then transferred to a processing unit configured to process the image and make it usable by executing the method described above.

The image resulting from this processing can subsequently be transferred to an external device, such as a personal computer, through a communication unit.

Alternatively, the processed image can be used within the camera itself for the execution of machine vision operations, with the results of these operations transferred to another unit via the communication unit.

The processing unit can be implemented by means of an FPGA, an MCU microcontroller, a CPU, a GPU, or any other type of integrated circuit (chip) capable of performing calculations and processing image data from the sensor. It is also possible to realize the processing unit as a combination of several components, having as a common purpose the processing of the image acquired by the sensor.

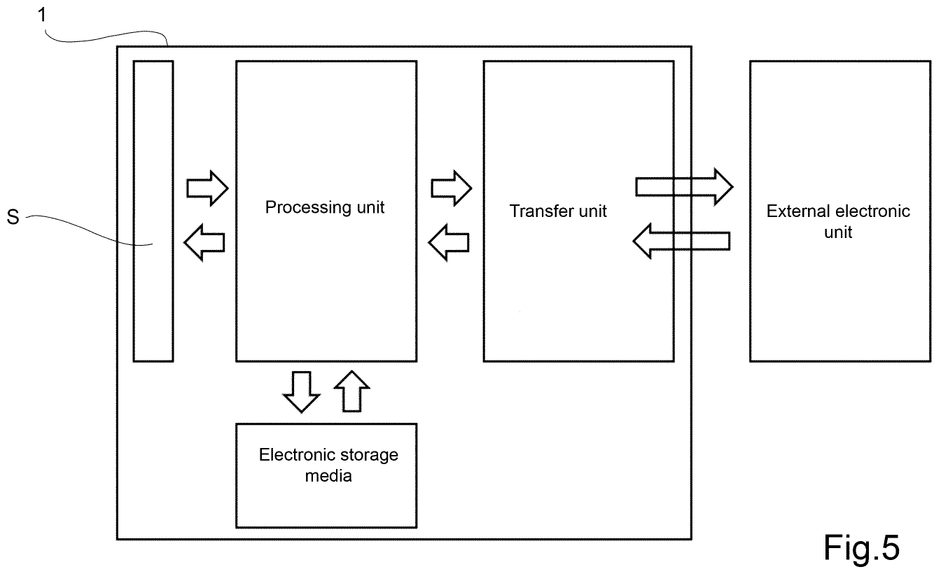

Furthermore, the present disclosure also relates to a vision system, illustrated by way of example in FIG. 5.

In a general embodiment, this vision system comprises an industrial camera 1 as described above.

This vision system further comprises an external electronic unit suitable for connection with the transfer unit.

Furthermore, the present disclosure also relates to a computer program executable by a processing device, comprising code instructions which, when executed by the processing device, cause the execution of the steps of the method described above.

Furthermore, the present disclosure also relates to a computer program product in which a computer program as described above is stored, suitable for being executed by a processing device to implement the steps of the method described above.

Innovatively, the method provided in the present disclosure fulfills the intended purpose, overcoming the limitations imposed by the depth of field and at the same time maintaining a high resolution.

The described method makes it possible to obtain a reconstructed image in which all the objects present in the operating range of the optical system are correctly focused. This image, thanks to its sharpness and extended focus, is directly usable as input for computer vision algorithms, simplifying and making more efficient the subsequent phases of analysis and automatic interpretation of images.

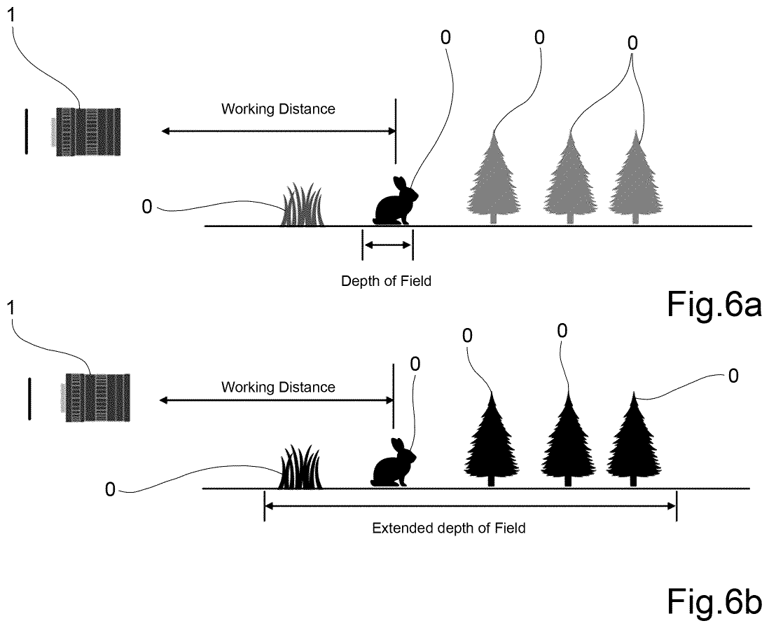

The multifocal optical element makes it possible to generate a plurality of object focus planes. The integration of this element is particularly useful for overcoming the limitations related to the depth of field, as it allows increasing the depth of field of the starting system and producing an extended depth of field, as illustrated by way of example in FIG. 6.

By using the multifocal optical element, it is possible to focus objects at different working distances. Therefore, by increasing the possibility of focusing different object planes, it is possible to overcome the limitations deriving from the depth of field of the objective.

The ability to acquire focused images over a wider range of distances makes the vision system less sensitive to variations in the position of objects.

A person skilled in the art may make modifications, adaptations, and substitutions of elements with other functionally equivalent ones to the embodiments of the computer-implemented method, the industrial camera, the vision system, the computer program, and the computer program product according to the disclosure to meet contingent needs, without departing from the scope of protection of the following claims. Each of the features described as belonging to a possible embodiment can be implemented independently of the other described embodiments.

1. A computer-implemented method for obtaining a focused object image from an object image of at least one observed object acquired using an image sensor optically coupled to a multifocal optical system, said method comprising the following steps:
a) using a deconvolution module, deconvolving the object image based on at least one optical parameter associated with the multifocal optical system, in order to obtain a deconvolved object image; and
b) using a post-deconvolution noise correction module, modifying the deconvolved object image based on the at least one optical parameter associated with the multifocal optical system, in order to obtain a focused object image.

2. The method according to claim 1, wherein before step a), the following step is provided:
0) using a sensor noise correction module, modifying the object image based on at least one sensor parameter associated with the image sensor, in order to obtain a noise-corrected object image;
and wherein step a) involves deconvolving the noise-corrected object image.

3. The method according to claim 2, wherein the sensor noise correction step comprises the following sub-steps:
0a) based on at least one sensor parameter associated with the image sensor, obtaining a noise profile image associated with said image sensor; and
0b) subtracting the noise profile image from the object image, in order to obtain a noise-corrected object image.

4. The method according to claim 2, wherein the at least one sensor parameter associated with the image sensor and/or the noise profile image associated with the image sensor are obtained from a database previously stored on electronic storage media.

5. The method according to claim 2, wherein the noise profile image associated with the image sensor corresponds to a Photo Response Non-Uniformity noise and/or a Dark Signal Non-Uniformity noise.

6. The method according to claim 1, wherein the deconvolution step involves deconvolving the noise-corrected object image based on a Point Spread Function and/or a Modulation Transfer Function associated with the multifocal optical system.

7. The method according to claim 1, wherein the post-deconvolution noise correction step involves modifying the deconvolved object image using a filter, for example, a Gaussian filter.

8. An industrial camera, comprising:
a camera body supporting at least one multifocal optical system optically coupled to at least one image sensor, said image sensor being suitable for acquiring at least one object image of at least one observed object; and
a processing unit configured to perform the steps of the method according to claim 1.

9. The industrial camera according to claim 8, further comprising:
an intensity modulator optically coupled to the multifocal optical system, said intensity modulator being configured to modulate in intensity the rays coming from the at least one observed object.

10. The industrial camera according to claim 9, further comprising:
a transfer unit configured to transfer the focused object image to at least one external electronic unit.

11. The industrial camera according to claim 8, wherein the multifocal optical system comprises a multifocal optical element, for example, an axicon.

12. A vision system, said system comprising:
an industrial camera according to claim 8; and
an external electronic unit suitable for connection to the transfer unit.

13. A computer program executable by a processing device, comprising code instructions which, when executed by the processing device, cause execution of the steps of the method according to claim 1.

14. A computer program product in which a computer program is stored in accordance with claim 13, suitable for being executed by a processing device to implement the steps of the method.
